(19) United States
(12) Patent Application Publication
(10) Pub. No.: US 2005/0184054 A1
(43) Pub. Date: Aug. 25, 2005

(54) Ceramics heater for semiconductor production system

(76) Inventors: Yoshifumi Kachi, Itami-shi (JP); Akira Kuibira, Itami-shi (JP); Hirohiko Nakata, Itami-shi (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(21) Appl. No.: 10/501,744

(22) PCT Filed: Mar. 20, 2003
(86) PCT No.: PCT/JP03/03481

(30) Foreign Application Priority Data
Oct. 24, 2002 (JP) 2002-309387

(51) Int. Cl. H05B 3/02

(52) U.S. Cl. 219/546

(57) ABSTRACT

Affords ceramic susceptors, for semiconductor manufacturing equipment, in which wafer-surface isothermal quality during heating operations is heightened by enhancing the degree of planarization of the susceptor wafer-carrying face in its high-temperature region where wafers are processed in the course of manufacturing semiconductors. Ceramic susceptor (1) for semiconductor manufacturing equipment has in the surface or interior of ceramic substrates (2a) and (2b) resistive heating element (3), and a non-heating (ordinary-temperature) arched contour in its wafer-carrying face is a concavity of 0.001 to 0.7 mm per 300 mm. A plasma electrode furthermore may be disposed in ceramic susceptor 1, in the surface or interior of ceramic substrates (2a) and (2b). Preferably, moreover, ceramic substrates (2a) and (2b) are at least one ceramic selected from aluminum nitride, silicon nitride, aluminum oxynitride, and silicon carbide.

### TECHNICAL FIELD

The present invention relates to ceramic susceptors employed to retain and heat wafers in semiconductor manufacturing equipment in which predetermined processes are carried out on the wafers in the course of semiconductor manufacture.

### BACKGROUND ART

A variety of structures for ceramic susceptors employed in semiconductor manufacturing equipment has been proposed to date. For example, a semiconductor wafer heating device equipped with a ceramic susceptor in which a resistive heating element is embedded and that is installed within a reaction chamber, and with a pillar-like support member that is provided on a surface of the susceptor apart from its wafer-heating face and forms a gastight seal between it and the chamber, is proposed in Japanese Pat. App. Pub. No. H06-28258.

In order to reduce manufacturing costs meanwhile, a transition to wafers of larger diametric span—from 8-inch to 12-inch in outer diameter—is in progress, along with which the ceramic susceptors that retain the wafers are turning out to be 300 mm in diameter or more. At the same time, isothermal ratings within ±1.0%, more desirably within ±0.5%, in the surface of wafers being heated by the ceramic susceptors are being called for.

In response to demands for such isothermal properties, given that when a wafer has been set in place on a ceramic susceptor gaps arising between the wafer-carrying face and the wafer make uniform heating impossible, precision-finishing the susceptor wafer-carrying face to raise its degree of planarization has been pursued. Nevertheless, accompanying the transition to wafers of larger diametric span, realizing what is being called for as just mentioned in wafer-surface isothermal quality is proving to be problematic.

Patent Reference 1

Japanese Pat. App. Pub. No. H06-28258.

Although, as just described, raising the degree of planarization in the susceptor wafer-carrying face has been pursued to date in order to improve wafer isothermal ratings, in recent years meeting isothermal quality demands as wafers continue to be scaled up diametrically is proving to be difficult.

For example, as set forth in the just-mentioned Japanese Pat. App. Pub. No. H06-28258, owing to the fact that with a support member being joined to the ceramic susceptor, heat that is generated when electric current flows through the resistive heating element is transmitted from the susceptor through the support member and escapes out into the reaction chamber, the thermal expansion coefficient of the support-member end of the susceptor is small by comparison to its wafer-carrying face, wherein stress tending to bulge the wafer-carrying face is placed on the susceptor. Consequently, even though the wafer-carrying face has been precision-finished to raise its degree of planarization at room-temperature, the surface isothermal quality of wafers when being processed on the susceptor has not risen, because in practice the wafer-carrying face buckles into a convex contour in its high-temperature region, producing gaps between it and the wafer and giving rise to non-uniformity in the conduction of heat into the wafer.

### DISCLOSURE OF INVENTION

An object of the present invention, in view of such circumstances to date, is to heighten the degree of planarization of ceramic-susceptor wafer-carrying faces in their high-temperature region where wafers are processed in the course of manufacturing semiconductors, to afford susceptors for semiconductor manufacturing equipment in which wafer-surface isothermal quality during heating operations is heightened.

In order to achieve the foregoing objective, the present invention renders a ceramic susceptor for semiconductor manufacturing equipment, having a resistive heating element in the surface or interior of its ceramic substrate, being a semiconductor-manufacturing-equipment ceramic susceptor characterized in that the wafer-carrying face in arched contour when not heating is a concavity of 0.001 to 0.7 mm/300 mm.

In the foregoing semiconductor-manufacturing-equipment ceramic susceptor of the present invention, the ceramic substrate preferably is made of at least one ceramic selected from aluminum nitride, silicon nitride, aluminum oxynitride, and silicon carbide.

Likewise, in the foregoing semiconductor-manufacturing-equipment ceramic susceptor of the present invention, the resistive heating element is preferably made from at least one metal selected from tungsten, molybdenum, platinum, palladium, silver, nickel, and chrome.

In addition, a plasma electrode furthermore may be disposed in the surface or interior of the ceramic substrate for the foregoing semiconductor-manufacturing-equipment ceramic susceptor of the present invention.

### BRIEF DESCRIPTION OF DRAWINGS

FIG. 1 is a schematic sectional view illustrating one specific example of a ceramic susceptor according to the present invention; and

FIG. 2 is a schematic sectional view illustrating a separate specific example of a ceramic susceptor according to the present invention.

### BEST MODE FOR CARRYING OUT THE INVENTION

As a result of investigating the degree of planarization in the wafer-carrying face of ceramic susceptors for semiconductor manufacturing equipment, the present inventors discovered that with conventional ceramic susceptors, the wafer-carrying face in general at ordinary temperature is in a warped state in which it trends convex (which hereinafter will also be termed the “plus direction”), wherein when the temperature rises by electricity being passed into the resistive heating element, lowering the Young's modulus, the plus-direction warpage becomes greater.

To address this, in the present invention, by modulating the warped state of the ceramic susceptor at ordinary temperature so that the wafer-carrying face trends concave (which hereinafter will also be termed the “minus direction”), heightening the degree of planarization of the wafer-carrying face in its high-temperature region over conventional levels when in practice a wafer is being treated was possible. In particular, with a ceramic susceptor of the present invention, the wafer-carrying face in arched contour when not heating (when at ordinary temperatures) is rendered a concavity of 0.001 to 0.7 mm per 300 mm length along the wafer-carrying face.

By rendering this sort of arched contour in the ceramic susceptor at ordinary temperature, during actual processing of a wafer the susceptor in the high-temperature region flexes in the plus direction, which therefore enhances the degree of planarization of the wafer-carrying face and practically eliminates gaps between it and the wafer. As a result, bringing wafer-surface isothermal ratings to within ±5% with ceramic susceptors whose thermal conductivity is 100 W/mK or more, and to within ±1.0% with ceramic susceptors of 10 to 100 W/mK, is possible in the present invention.

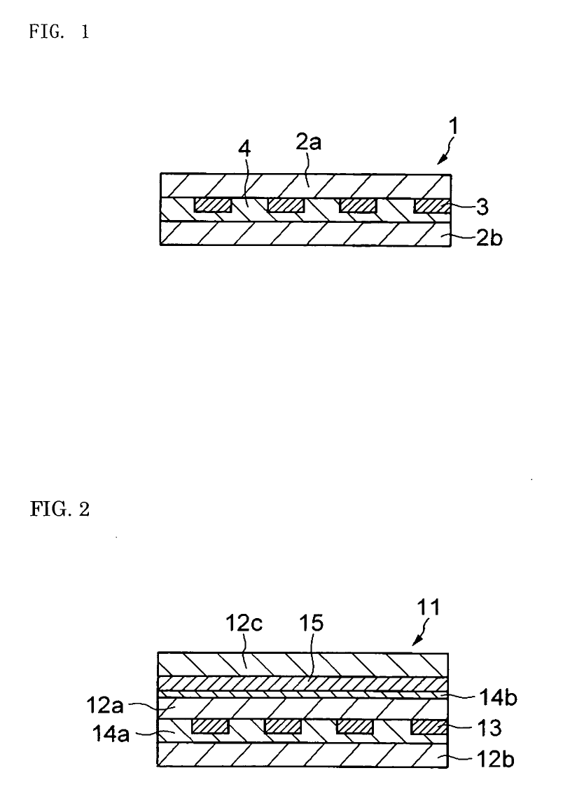

Next, a specific structure for a ceramic susceptor that is given by the present invention will be explained according to FIGS. 1 and 2. The ceramic susceptor 1 depicted in FIG. 1 is provided on one surface of its ceramic substrate 2a with a resistive heating element 3 of a predetermined circuit pattern, and a separate ceramic substrate 2b is joined onto that surface by means of a bonding layer 4 made out of glass or ceramic. Here, the circuit pattern for the resistive heating element 3 is formed so that for example the linewidth and line spacing will be 5 mm or less, more preferably 1 mm or less.

Likewise, a ceramic susceptor 11 depicted in FIG. 2 is in the interior thereof furnished with a resistive heating element 13 and meanwhile with a plasma electrode 15. In particular, similarly to the ceramic susceptor 1 of FIG. 1, a ceramic substrate 12a that on one surface has the resistive heating element 13 is joined to a ceramic substrate 12b with a bonding layer 4, but meanwhile a separate ceramic substrate 12c on which the plasma electrode 15 is provided is joined to the other surface of the ceramic substrate 12a by means of a bonding layer 14b made out of glass or ceramic.

It should be understood that in manufacturing the ceramic susceptors represented in FIGS. 1 and 2, apart from the method of joining the respective ceramic substrates, green sheets of approximately 0.5 mm thickness may be prepared, and after utilizing an electrically conductive paste to print-coat onto each green sheet circuit patterns for the resistive heating element and/or the plasma electrode, these green sheets, as well as ordinary green sheets as needed, may be laminated to produce the required thickness and made unitary by sintering them simultaneously.

### EMBODIMENTS

### Embodiment 1

A sintering additive and a binder were added to, and, using a ball mill, dispersed into and mixed with, aluminum nitride (AlN) powder. After drying it with a spray dryer, the powder blend was press-molded into discoid plates of 380 mm diameter and 1 mm thickness. Sintered AlN compacts were produced by degreasing, within a non-oxidizing atmosphere at a temperature of 800° C., the obtained molded objects and then sintering them 4 hours at a temperature of 1900° C. The thermal conductivity of the AlN sinters was 170 W/mK. The circumferential surface of the sintered AlN compacts was polished to bring their outer diameter down to 300 mm, whereby disk pairs of AlN substrates for ceramic susceptors were prepared.

A paste, being tungsten powder and a sintering additive knead-mixed into a binder, was print-coated to form a predetermined heating-element circuit pattern onto a face of first disks from the AlN substrate pairs. Resistive heating elements of tungsten were formed by degreasing these AlN substrates within a non-oxidizing atmosphere at a temperature of 800° C., and then baking them at a temperature of 1700° C.

A paste in which a Y₂O₃ adhesive agent and a binder were knead-mixed was print-coated onto a face of the remaining, second disks from the AlN substrate pairs, which were then degreased at a temperature of 500° C. This adhesive-agent layer on the AlN second substrate disks was overlaid onto the side of the first AlN substrate disks where the resistive heating element was formed, and the first/second disk pairs were bonded together by heating them at a temperature of 800° C., whereby ceramic susceptors made of AlN were produced.

In addition, pipe-shaped support members made out of sintered AlN material were produced by compacting the foregoing spray-dried aluminum nitride powder in a cold isostatic press (CIP) at 1 ton/cm² so as to mold compacts whose post-sintering dimensions would be 100 mm outside diameter, 90 mm inside diameter, and 200 mm length, and degreasing the compacts within a non-oxidizing atmosphere at 800° C. and baking them 4 hours at 1900° C.

One end face of the AlN pipe-shaped support members was set in place in the center of the AlN ceramic susceptors and hot-press joined to them by heating 2 hours at a temperature of 800° C. In doing so, by modulating warpage in the sample holder when the hot-press joint formed, the initial warpage in the ceramic susceptors following joint formation was varied sample by sample to be the values set forth in Table I below.

To evaluate the ceramic susceptors thus produced having the FIG. 1 structure, the susceptor temperature was elevated to 500° C. by passing an electric current into the resistive heating element at a voltage of 200 V, through twin electrodes formed on the surface of the susceptor on the side opposite its wafer-carrying face, wherein warpage at 500° C. in the wafer-carrying face of the ceramic susceptors was measured.

In addition, a silicon wafer of 0.8 mm thickness and 300 mm diameter was set atop the wafer-carrying face of the ceramic susceptors, and the isothermal rating of the wafer surface was found by measuring the wafer surface-temperature distribution during the time the susceptor was heated to 500° C. as just noted. The results obtained are shown in Table I below for each of the samples. It should be understood that in the warpage columns in Table I, “+” indicates that the flexing direction is the plus direction (convexity), and “−,” that the fixing direction is the minus direction (concavity). (The same is true for each of tables in the following.)

TABLE I

| | Initial warpage | 500° C. warpage | Wafer-surface isothermal |
|---|---|---|---|
| Sample | (mm/300 mm) | (mm/300 mm) | rating at 500° C. (%) |
| 1* | ±0.03 | +0.6 | ±0.9 |
| 2* | ±0.0 | +0.51 | ±0.7 |
| 3 | −0.001 | +0.45 | ±0.5 |
| 4 | −0.1 | +0.4 | ±0.45 |
| 5 | −0.5 | +0.03 | ±0.4 |
| 6 | −0.7 | −0.2 | ±0.5 |
| 7* | −0.8 | −0.5 | ±0.62 |
| 8* | −1.0 | −0.7 | ±0.85 |

Note:
Samples marked with an asterisk (*) in the table are comparative examples.

As indicated in the above Table I, in order to obtain sought-after wafer-surface isothermal ratings (within ±0.5%) in ceramic susceptors made of AlN, the susceptor wafer-carrying face in an initial arched contour must be rendered a concavity of within a range of 0.001 to 0.7 mm/300 mm.

### Embodiment 2

A sintering additive and a binder were added to, and, using a ball mill, dispersed into and mixed with, silicon nitride (Si₃N₄) powder. After drying it with a spray dryer, the powder blend was press-molded into discoid plates of 380 mm diameter and 1 mm thickness. Sintered Si₃N₄ compacts were produced by degreasing, within a non-oxidizing atmosphere at a temperature of 800° C., the molded objects and then sintering them 4 hours at a temperature of 1550° C. The thermal conductivity of the sintered Si₃N₄ compacts was 20 W/mK. The circumferential surface of the sintered Si₃N₄ compacts was polished to bring their outer diameter down to 300 mm, whereby disk pairs of Si₃N₄ substrates for ceramic susceptors were prepared.

Resistive heating elements of tungsten were formed onto a face of first disks from the Si₃N₄ substrate pairs by the same method as in Embodiment 1. An SiO₂ adhesive-agent layer was formed superficially onto the remaining, second disks from the Si₃N₄ substrate pairs, which were overlaid onto the side of the first Si₃N₄ substrate disks where the resistive heating element was formed, and the first/second disk pairs were bonded together by heating them at a temperature of 800° C., whereby ceramic susceptors made of Si₃N₄ were produced.

In addition, pipe-shaped support members made out of sintered Si₃N₄ material were produced by compacting the foregoing spray-dried silicon nitride powder in a CIP at 1 ton/cm² so as to mold compacts whose post-sintering dimensions would be 100 mm outside diameter, 90 mm inside diameter, and 200 mm length, and degreasing the compacts within a non-oxidizing atmosphere at a temperature of 800° C. and baking them 4 hours at 1900° C.

One end face of the Si₃N₄ pipe-shaped support members was set in place in the center of the Si₃N₄ ceramic susceptors and joined to them by heating 2 hours at a temperature of 800° C. In doing so, by modulating warpage in the sample holder when the hot-press joint formed, the initial warpage in the ceramic susceptors following joint formation was varied sample by sample to be the values set forth in Table II below.

To evaluate the ceramic susceptors thus produced having the FIG. 1 structure, the susceptor temperature was elevated to 500° C. by passing an electric current into the resistive heating element at a voltage of 200 V, through twin electrodes formed on the surface of the susceptor on the side opposite its wafer-carrying face, wherein warpage in the wafer-carrying face at 500° C. was measured. In addition, the isothermal rating of a silicon wafer of 0.8 mm thickness and 300 mm diameter set atop the wafer-carrying face of the ceramic susceptors was found by measuring the wafer surface-temperature distribution. The results obtained are shown in Table II below for each of the samples.

TABLE II

| | Initial warpage | 500° C. warpage | Wafer-surface isothermal |
|---|---|---|---|
| Sample | (mm/300 mm) | (mm/300 mm) | rating at 500° C. (%) |
| 9* | ±0.0 | +0.54 | ±1.21 |
| 10 | −0.003 | +0.46 | ±0.98 |
| 11 | −0.12 | +0.4 | ±0.90 |
| 12 | −0.5 | +0.03 | ±0.76 |
| 13 | −0.65 | −0.2 | ±0.98 |
| 14* | −0.8 | −0.55 | ±1.19 |

Note:
Samples marked with an asterisk (*) in the table are comparative examples.

As indicated in the above Table II, also with silicon-nitride ceramic susceptors whose thermal conductivity is 20 W/mK, by rendering the susceptor wafer-carrying face in an initial arched contour to be a concavity of within a range of 0.001 to 0.7 mm/300 mm in the minus direction, sought-after wafer-surface isothermal ratings (within +1.0%) could be procured.

### Embodiment 3

A sintering additive and a binder were added to, and, using a ball mill, dispersed into and mixed with, aluminum oxynitride (AlON) powder. After drying it with a spray dryer, the powder blend was press-molded into discoid plates of 380 mm diameter and 1 mm thickness. Sintered AlON compacts were produced by degreasing, within a non-oxidizing atmosphere at a temperature of 800° C., the molded objects and then sintering them 4 hours at a temperature of 1770° C. The thermal conductivity of the sintered AlON compacts was 20 W/mK. The circumferential surface of the obtained sintered AlON compacts was polished to bring their outer diameter down to 300 mm, whereby disk pairs of AlON substrates for ceramic susceptors were prepared.

Resistive heating elements of tungsten were formed onto a face of first disks from the AlON substrate pairs by the same method as in Embodiment 1. An SiO₂ adhesive-agent layer was formed superficially onto the remaining, second disks from the AlON substrate pairs, which were overlaid onto the side of the first AlON substrate disks where the resistive heating element was formed, and the first/second disk pairs were bonded together by heating them at a temperature of 800° C., whereby ceramic susceptors made of AlON were produced.

In addition, pipe-shaped support members made out of sintered AlON material were produced by compacting the foregoing spray-dried aluminum oxynitride powder in a CIP at 1 ton/cm² so as to mold compacts whose post-sintering dimensions would be 100 mm outside diameter, 90 mm inside diameter, and 200 mm length, and degreasing the compacts within a non-oxidizing atmosphere at 800° C. and baking them 4 hours at 1900° C.

One end face of the AlON pipe-shaped support members was set in place in the center of the AlON ceramic susceptors and joined to them by heating 2 hours at a temperature of 800° C. In doing so, by modulating warpage in the sample holder when the hot-press joint formed, the initial warpage in the ceramic susceptors following joint formation was varied sample by sample to be the values set forth in Table III below.

To evaluate the ceramic susceptors thus produced having the FIG. 1 structure, the susceptor temperature was elevated to 500° C. by passing an electric current into the resistive heating element at a voltage of 200 V, through twin electrodes formed on the surface of the susceptor on the side opposite its wafer-carrying face, wherein warpage in the wafer-carrying face at 500° C. was measured. In addition, the isothermal rating of a silicon wafer of 0.8 mm thickness and 300 mm diameter set atop the wafer-carrying face of the ceramic susceptors was found by measuring the wafer surface-temperature distribution. The results obtained are shown in Table III below for each of the samples.

TABLE III

| | Initial warpage | 500° C. warpage | Wafer-surface isothermal |
|---|---|---|---|
| Sample | (mm/300 mm) | (mm/300 mm) | rating at 500° C. (%) |
| 15* | ±0.0 | +0.55 | ±1.18 |
| 16 | −0.001 | +0.45 | ±1.00 |
| 17 | −0.09 | +0.4 | ±0.86 |
| 18 | −0.45 | +0.03 | ±0.80 |
| 19 | −0.7 | −0.2 | ±1.00 |
| 20* | −0.8 | −0.5 | ±1.20 |

Note:
Samples marked with an asterisk (*) in the table are comparative examples.

As indicated in the above Table III, also with aluminum oxynitride ceramic susceptors whose thermal conductivity is 20 W/mK, by rendering the susceptor wafer-carrying face in an initial arched contour to be a concavity of within a range of 0.001 to 0.7 mm/300 mm in the minus direction, sought-after wafer-surface isothermal ratings (within ±1.0%) could be procured.

### Embodiment 4

Disk pairs of ceramic-susceptor AlN substrates 300 mm in diameter, made out of sintered aluminum nitride material, as well as pipe-shaped support members made of AlN, were manufactured by the same method as in Embodiment 1.

Next, in utilizing the AlN substrate pairs to fabricate ceramic susceptors, the material for the resistive heating element provided on the one face of the first disks from the AlN substrate pairs was switched to Mo, to Pt, to Ag—Pd, and to Ni—Cr, respective pastes of which were printed-coated, and fired within a non-oxidizing atmosphere, onto respective first-disk faces.

After that the remaining, second disks from the AlN substrate pairs were coated with an SiO₂ bonding agent and overlaid onto the side of the first AlN substrate disks where the resistive heating element was formed, wherein AlN ceramic susceptors were produced in the same manner as in Embodiment 1, apart from the SiO₂ bonding agent also being applied to where the joint with the pipe-shaped support member made of AlN was, and the susceptors being degreased at 800° C. in a non-oxidizing atmosphere to bond the joints at 800° C. In doing so, by modulating warpage in the sample holder when the joint formed, the initial warpage in the ceramic susceptors following joint formation was varied sample by sample to be the values set forth in Table IV below.

To evaluate the ceramic susceptors thus produced differing in resistive-heating-element substance, the susceptor temperature was elevated to 500° C. by passing an electric current into the resistive heating element at a voltage of 200 V, through twin electrodes formed on the surface of the susceptor on the side opposite its wafer-carrying face, wherein warpage in the wafer-carrying face at 500° C. was measured. In addition, the isothermal rating of a silicon wafer of 0.8 mm thickness and 300 mm diameter set atop the wafer-carrying face of the ceramic susceptors was found by measuring the wafer surface-temperature distribution. The results obtained are shown in Table IV below for each of the samples.

TABLE IV

| | Resistive heating | Initial warpage | Wafer-surface isothermal |
|---|---|---|---|
| Sample | element | (mm/300 mm) | rating (%) at 500° C. |
| 21* | Mo | ±0.0 | ±0.64 |
| 22 | Mo | −0.002 | ±0.45 |
| 23 | Mo | −0.11 | ±0.43 |
| 24 | Mo | −0.55 | ±0.43 |
| 25 | Mo | −0.69 | ±0.5 |
| 26* | Mo | −0.8 | ±0.54 |
| 27* | Pt | ±0.0 | ±0.62 |
| 28 | Pt | −0.001 | ±0.5 |
| 29 | Pt | −0.09 | ±0.43 |
| 30 | Pt | −0.45 | ±0.4 |
| 31 | Pt | −0.7 | ±0.5 |
| 32* | Pt | −0.8 | ±0.63 |
| 33* | Ag—Pd | ±0.0 | ±0.67 |
| 34 | Ag—Pd | −0.003 | ±0.5 |
| 35 | Ag—Pd | −0.12 | ±0.45 |
| 36 | Ag—Pd | −0.5 | ±0.4 |
| 37 | Ag—Pd | −0.68 | ±0.5 |
| 38* | Ag—Pd | −0.8 | ±0.56 |
| 39* | Ni—Cr | ±0.0 | ±0.61 |
| 40 | Ni—Cr | −0.001 | ±0.46 |
| 41 | Ni—Cr | −0.09 | ±0.43 |
| 42 | Ni—Cr | −0.45 | ±0.4 |
| 43 | Ni—Cr | −0.7 | ±0.5 |
| 44* | Ni—Cr | −0.8 | ±0.61 |

Note:
Samples marked with an asterisk (*) in the table are comparative examples.

As indicated in Table IV above, with cases where the resistive heating element was Mo, Pt, Ag—Pd and Ni—Cr, by rendering the susceptor wafer-carrying face in an initial arched contour to be a concavity of within a range of 0.001 to 0.7 mm/300 mm in the minus direction, favorable results similar to those in Embodiment 1 in terms of wafer-surface isothermal ratings during the heating operation could be procured.

### Embodiment 5

Utilizing a paste in which a sintering additive, a binder, a dispersing agent and alcohol were added and knead-mixed into aluminum nitride powder, green sheets approximately 0.5 mm in thickness were produced by molding using a doctor-blading technique.

Next, after drying the green sheets 5 hours at 80° C. a resistive-heating-element layer in a given circuit pattern was formed by print-coating a paste, in which tungsten powder and a sintering additive were knead-mixed with a binder, onto a face of single plies of the green sheets. In addition, a plasma electrode layer was formed by print-coating the tungsten paste just described onto a face of separate single plies of the green sheets that had been likewise dried. The 2 plies of the green sheets having electrically conductive layers were laminated in 50 plies total with green sheets on which no conductive layer had been printed, and the laminates were united by heating them at a temperature of 140° C. while subjecting them to a pressure of 70 kg/cm².

After being degreased 5 hours within a non-oxidizing atmosphere at 600° C., the obtained laminates were hot-pressed at 100 to 150 kg/cm² pressure and 1800° C. temperature to produce aluminum nitride plate material of 3 mm thickness. This was cut out into discoid plates of 380 mm diameter, the periphery of which was polished down until the plates were 300 mm in diameter, whereby AlN ceramic susceptors of the FIG. 2 structure, internally having a resistive heating element and plasma electrodes were produced.

An end face of AlN pipe-shaped support members fashioned by the same method as in Embodiment 1 was set in place in the center of the above-described ceramic susceptors and joined to them by heating 2 hours at a temperature of 800° C. Here, by modulating warpage in the sample holder when the joint formed, the initial warpage in the ceramic susceptors following joint formation was varied sample by sample to be the values set forth in Table V below.

To evaluate the ceramic susceptors produced in this way, the susceptor temperature was elevated to 500° C. by passing an electric current into the resistive heating element at a voltage of 200 V, through twin electrodes formed on the surface of the susceptor on the side opposite its wafer-carrying face, wherein warpage in the wafer-carrying face at 500° C. was measured. In addition, the isothermal rating of a silicon wafer of 0.8 mm thickness and 300 mm diameter set atop the wafer-carrying face of the ceramic susceptors was found by measuring the wafer surface-temperature distribution. The results obtained are shown in Table V below for each of the samples.

TABLE V

| | Initial warpage | 500° C. warpage | Wafer-surface isothermal |
|---|---|---|---|
| Sample | (mm/300 mm) | (mm/300 mm) | rating at 500° C. (%) |
| 45* | ±0.0 | +0.57 | ±0.61 |
| 46 | −0.001 | +0.46 | ±0.48 |
| 47 | −0.09 | +0.4 | ±0.43 |
| 48 | −0.53 | +0.03 | ±0.38 |
| 49 | −0.67 | −0.2 | ±0.49 |
| 50* | −0.80 | −0.55 | ±0.61 |

Note:
Samples marked with an asterisk (*) in the table are comparative examples.

As indicated in the above Table V, also with ceramic susceptors having a resistive heating element and plasma electrodes, by rendering the susceptor wafer-carrying face in an initial arched contour to be a concavity of within a range of 0.001 to 0.7 mm/300 mm in the minus direction, favorable results with regard to wafer-surface isothermal ratings during the heating operation could be procured.

### INDUSTRIAL APPLICABILITY

In accordance with the present invention, heightening the degree of planarization of the wafer-carrying face of ceramic susceptors in the high-temperature region thereof where wafers are processed in the course of manufacturing semiconductors affords susceptors for semiconductor manufacturing equipment in which wafer-surface isothermal quality during heating operations is heightened.

1. For semiconductor manufacturing equipment, a ceramic susceptor comprising:
a ceramic substrate;
a resistive heating element formed either superficially or interiorly in said ceramic substrate; and
a concavity molded in a wafer-carrying face defined on a surface of said ceramic substrate through which said resistive heating element issues heat when the susceptor performs a heating operation, said concavity being 0.001 to 0.7 mm/300 mm in negative arched contour when the susceptor is not heating.

2. A ceramic susceptor as set forth in claim 1, wherein the ceramic substrate is made of at least one ceramic selected from aluminum nitride, silicon nitride, aluminum oxynitride, and silicon carbide.

3. A ceramic susceptor as set forth in claim 1, wherein the resistive heating element is made from at least one metal selected from tungsten, molybdenum, platinum, palladium, silver, nickel, and chrome.

4. A ceramic susceptor as set forth in claim 1, further comprising a plasma electrode disposed either in the surface or in the interior of said ceramic substrate.

5. A ceramic susceptor as set forth in claim 2, wherein the resistive heating element is made from at least one metal selected from tungsten, molybdenum, platinum, palladium, silver, nickel, and chrome.

6. A ceramic susceptor as set forth in claim 2, further comprising a plasma electrode disposed either in the surface or in the interior of said ceramic substrate.

7. A ceramic susceptor as set forth in claim 3, further comprising a plasma electrode disposed either in the surface or in the interior of said ceramic substrate.

8. A ceramic susceptor as set forth in claim 5, further comprising a plasma electrode disposed either in the surface or in the interior of said ceramic substrate.
